(19) United States
(12) Patent Application Publication
(10) Pub. No.: US 2024/0348517 A1
(43) Pub. Date: Oct. 17, 2024

(54) PACKET SIGNATURE BASED QUALITY OF SERVICE (QOS) CLASSIFICATION

(71) Applicant: Huawei Technologies Co., Ltd., Shenzhen (CN)

(72) Inventors: Kaippallimalil Mathew John, Carrollton, TX (US); Zhixian Xiang, Frisco, TX (US); Khosrow Tony Saboorian, Plano, TX (US)

(21) Appl. No.: 18/753,155

(22) Filed: Jun. 25, 2024

Related U.S. Application Data
(63) Continuation of application No. PCT/US2022/050394, filed on Nov. 18, 2022.
(60) Provisional application No. 63/269,948, filed on Mar. 25, 2022.
(60) Provisional application No. 63/303,819, filed on Jan. 27, 2022.

(51) Int. Cl. H04L 43/028; H04W 28/02; H04W 48/18

(52) U.S. Cl. CPC H04L 43/028; H04W 28/0268; H04W 48/18

(57) ABSTRACT

A network node receives a packet in an internet protocol (IP) flow; determines that the packet in the IP flow is a media packet using an enhanced media identification filter; obtains a packet priority mark (PPM) for the media packet, the PPM indicating an importance of the media packet; obtains a protocol data unit (PDU) sequence mark (PSM) for the media packet, the PSM indicating a sequence number for a PDU set to which the media packet belongs; and processes the media packet in accordance with the PPM, the PSM, and a congestion level.

### CROSS-REFERENCE TO RELATED APPLICATIONS

This patent application is a continuation of PCT/US2022/050394, filed Nov. 18, 2022, and entitled “Packet Signature Based Quality of Service (QOS) Classification”, which claims priority to U.S. Provisional Application No. 63/303,819, filed on Jan. 27, 2022 and entitled “Packet Signature Based Quality of Service (QOS) Classification,” and U.S. Provisional Application No. 63/269,948, filed on Mar. 25, 2022 and entitled “QoS Handling Extensions for Media Units,” applications of which are incorporated by reference herein as if reproduced in their entireties.

### TECHNICAL FIELD

The present disclosure relates generally to managing the network flows in a network, and in particular embodiments, to techniques and mechanisms for classifying and applying quality of service (QOS) to application flows (packets and/or frames) in a differentiated manner such that different packets/frames maybe treated according to the priority and type of the packet when the network is congested.

### BACKGROUND

Enhancements for support of extended reality (XR) media in 5th generation (5G) systems (5GS) enable high data rate and low latency flows. During congestion or radio resource constraints, packets of a flow are dropped randomly, which results in important packets (e.g., an I-frame in a video stream) being dropped. Furthermore, applications may carry traffic frames which may span more than one packet (which impacts more than just the packet dropped). The present disclosure addresses these technical problems by providing techniques and mechanisms for classifying packets and frames of a flow in a differentiated manner, and handling the Qos drop priorities within a flow.

### SUMMARY

Technical advantages are generally achieved, by embodiments of this disclosure which describe techniques and mechanisms for classifying packets and frames of a flow and handling the QoS drop priorities within a flow.

In accordance with an embodiment, a method is provided. The method comprises receiving, by a network node, a packet in an internet protocol (IP) flow; determining, by the network node, that the packet in the IP flow is a media packet using an enhanced media identification filter; obtaining, by the network node, a packet priority mark (PPM) for the media packet, the PPM indicating an importance of the media packet; obtaining, by the network node, a protocol data unit (PDU) sequence mark (PSM) for the media packet, the PSM indicating a sequence number for a PDU set to which the media packet belongs; and processing, by the network node, the media packet in accordance with the PPM, the PSM, and a congestion level.

Optionally, in any of the preceding aspects, the PDU set is a subset of a quality of service (QOS) flow, and wherein the QoS flow includes a second PDU set, each packet of the second PDU set includes a second PSM indicating a second sequence number different from the sequence number, the second PDU set corresponding to a second PPM different from the PPM.

Optionally, in any of the preceding aspects, the QoS flow corresponds to a video stream, wherein the PDU set corresponds to a video frame of the video stream, and wherein the second PDU set corresponds to a second video frame of the video stream different from the video frame.

Optionally, in any of the preceding aspects, the processing comprises determining whether to forward or drop the media packet in accordance with the PPM, the PSM, and the congestion level.

Optionally, in any of the preceding aspects, the obtaining the PPM comprises obtaining, by the network node, the PPM using the enhanced media identification filter.

Optionally, in any of the preceding aspects, the obtaining the PPM comprises mapping application meta-data in the media packet to the PPM in accordance with a mapping rule in the enhanced media identification filter, the mapping rule being statically setup in the network node.

Optionally, in any of the preceding aspects, the mapping rule is signaled to the network node via an application function (AF) and a session management function (SMF).

Optionally, in any of the preceding aspects, the media packet is a real time transport protocol (RTP) packet, and wherein the obtaining the PPM comprises mapping information in an RTP payload of the RTP packet to the PPM.

Optionally, in any of the preceding aspects, the obtaining the PPM comprises setting the PPM in accordance with at least one of a NAL independent layer or a NAL base layer.

Optionally, in any of the preceding aspects, the obtaining the PPM comprises determining that a configured NAL independent (I) flag is set to 1, and setting the PPM to indicate a high importance in response to the configured NAL I flag being set to 1.

Optionally, in any of the preceding aspects, the obtaining the PPM comprises mapping NAL priority field values for enhanced layers to the PPM in accordance with an application preference for motion or quality.

Optionally, in any of the preceding aspects, the obtaining the PPM comprises determining that no NAL application specific information is configured, and setting the PPM to indicate a low importance in in response to no NAL application specific information being configured.

Optionally, in any of the preceding aspects, the media packet is a secure real time transport protocol (SRTP) packet including an unencrypted extended header, and wherein the obtaining the PPM comprises mapping coded media information in the unencrypted extended header to the PPM.

Optionally, in any of the preceding aspects, the obtaining the PPM comprises setting the PPM to indicate a high importance in response to an I flag in the unencrypted extended header being set to 1.

Optionally, in any of the preceding aspects, the obtaining the PPM comprises setting the PPM in accordance with application meta-data in the unencrypted extended header.

Optionally, in any of the preceding aspects, the obtaining the PPM comprises determining that a D flag in the unencrypted extended header is set to 1, and setting the PPM to indicate a low importance in response to the D flag being set to 1.

Optionally, in any of the preceding aspects, the obtaining the PPM comprises mapping at least one of a temporal identifier (TID), a layer identifier (LID), or a temporal layer zero picture index (TLoPICIDX) value in the unencrypted extended header to the PPM based on an application preference for motion or quality.

Optionally, in any of the preceding aspects, the obtaining the PPM comprises setting the PPM to indicate a low importance in response to the unencrypted extended header including no configuration related to the PPM.

Optionally, in any of the preceding aspects, the media packet is one of a secure real time transport protocol (SRTP) packet or a hypertext transfer protocol (HTTP) packet including an encrypted payload, the encrypted payload including a media payload and headers, and wherein the obtaining the PPM comprises mapping information in the media packet to the PPM using a configured rule in the enhanced media identification filter, the configured rule obtained from a control plane node.

Optionally, in any of the preceding aspects, an application function (AF) node configures the configured rule to the control plane node, and wherein the configured rule specifies parameters in at least one of one or more IP headers, one or more transport headers, or one or more payload headers for mapping to the PPM.

Optionally, in any of the preceding aspects, the obtaining the PPM comprises mapping at least one of one or more IPv6 flow labels, a differentiated service code point (DSCP) field, or a sending port field to the PPM using the configured rule.

Optionally, in any of the preceding aspects, the obtaining the PPM comprises setting the PPM to indicate a low importance in response to at least one IP header field including no configuration related to the PPM using the configured rule.

Optionally, in any of the preceding aspects, the obtaining the PPM comprises setting the PPM to indicate a high importance based on the media packet being in an independent frame as specified in the configured rule, or setting the PPM to indicate a low importance based on the media packet being in a discardable frame as specified in the configured rule, or setting the PPM based on an application preference for motion or quality as specified in the configured rule.

Optionally, in any of the preceding aspects, the obtaining the PPM comprises extracting the PPM in the media packet.

Optionally, in any of the preceding aspects the obtaining the PPM comprises determining, by the network node, that there is a match between a data network name (DNN) or a single-network slice selection assistance information (S-NSSAI) and a QoS flow of the PDU set, and setting, by the network node, the PPM in accordance with at least one of a packet type, a service address, a port, a protocol, a frame information field, a payload size, a packet rate, or a packet idle time.

In accordance with yet another embodiment, a network node for performing any of the preceding methods or aspects of the methods is provided. The network node comprises one or more processors; and a non-transitory memory storage storing instructions that, when executed by the one or more processors, cause the network node to perform a method of any of the preceding methods or aspects of the methods.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an embodiment wireless communications network;

FIG. 2 illustrates an example of a user equipment (UE) packet signature provisioning flow between an application server (AS) and a UE according to example embodiments disclosed herein;

FIG. 3 illustrates an example of packet signature data according to embodiments disclosed herein;

FIG. 4 illustrates example data structures to provision the packet/frame signature and priority mark according to example embodiments disclosed herein;

FIG. 5 illustrates differentiated QoS per packet according to example embodiments disclosed herein;

FIG. 6 illustrates example drop rate tables according to example embodiments disclosed herein;

FIG. 7 illustrates a flowchart of enhanced QoS handling according to example embodiments disclosed herein;

FIG. 8 illustrates an example of configuring and storing PSD and QoS policy according to example embodiments disclosed herein;

FIG. 9 illustrates PSD Management in SMF according to example embodiments disclosed herein;

FIG. 10 illustrates PSD Configuration in TA according to example embodiments disclosed herein;

FIG. 11 illustrates a model of packet size and latency addition in core network;

FIG. 12 illustrates a sequence of operations according to some example embodiments disclosed herein;

FIG. 13 illustrates the identification of the start and end of a PDU set according to some example embodiments disclosed herein;

FIG. 14 illustrates a QoS Model with extension for Media Packet Classification according to example embodiments disclosed herein;

FIG. 15 illustrates a flowchart of extended QoS handling according to example embodiments disclosed herein;

FIG. 16 illustrates an example of QoS media classification in GTP-U extension according to example embodiments disclosed herein;

FIG. 17 illustrates an example communication system according to example embodiments presented herein;

FIG. 18A and FIG. 18B illustrate example devices that may implement the methods and teachings according to this disclosure; and

FIG. 19 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

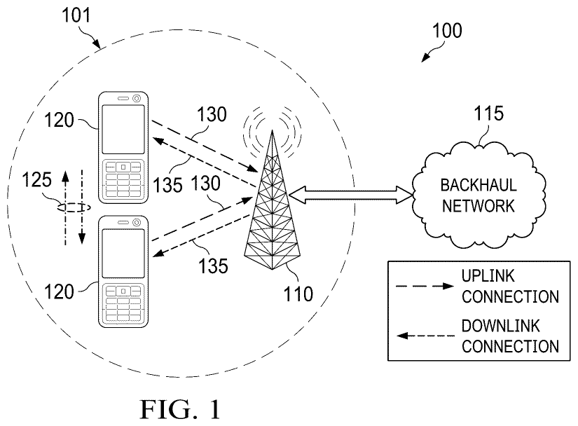

FIG. 1 illustrates an example communications system 100. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), fifth generation (5G), 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

Disclosed herein are methods and techniques for classifying and applying QoS to application flows (including packets and/or frames in the application flows) in a differentiated manner, i.e., different packets/frames maybe treated according to the priority and type of the packet when the network is congested. The mechanisms for differentiated QoS can be in addition to the current QoS flow based handling in 3GPP TS23.501, clause 5.7. The scope of classifying and handling in this disclosure may be within (a) 3GPP network between the user equipment (UE) and the N6 (IP) interface that is operated by the 5G network provider, or (b) flows between UEs in one or more 3GPP networks. Since between 80% and 95% of internet traffic is encrypted, the solution can also be designed to take encryption into consideration.

The technical problems addressed here include:
1. support for classification of packets and frames of a flow in a differentiated manner,
2. control plane (e.g., 5G core network (5GC), application function (AF)) mechanisms to indicate fine-grained, packet signature based QoS handling of application traffic, and
3. user plane protocol for carrying per packet/frame classification in 3GPP general packet radio service (GPRS) tunneling protocol (GTP).

Extended QoS for classifying on per-packet/frame would ideally be better applied between the two transport connection end points. However, this may not be practical within the current network and protocols, because there is no way to carry this meta data in the transport layer (L4) headers or IP headers. Flow label, DSCP, and ECN are not sufficient to provide differentiated QoS marking for packets of a flow. The expectation is that when the network is highly congested, packets classified with these differentiated markers (in addition to classic 3GPP QoS info) can provide information to allow smart and more effective queue management and scheduling for packets within a flow.

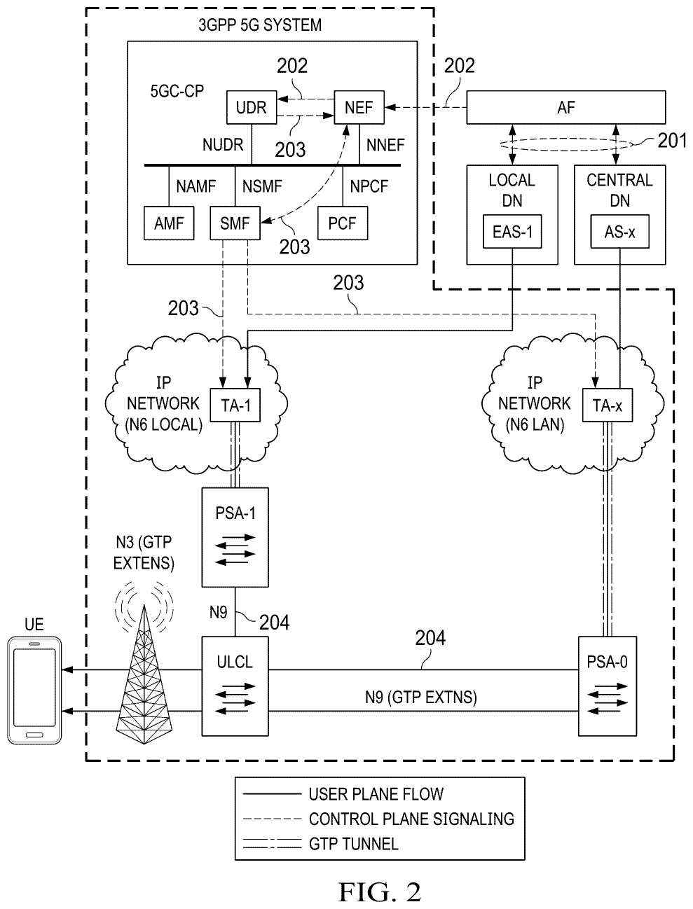

In addition to the lack of header options to carry differentiated QoS information, the embodiment solutions can also consider that packets are likely to be encrypted. This limits the option to perform deep packet inspection, but it is still possible to use information programmed or learned about the type of packet, sequence—in general, an application signature. The handling of QoS packet/frame priority is possible for application server (AS)—UE flows and UE—UE flows. FIG. 2 shows an overview of AS—UE flows and includes a 3GPP architecture with the addition of a new entity-transport assistant (TA), according to some embodiments.

The sequence of high level operations to provision and install packet signature descriptions (PSD) and then apply packet priority marking (PPM) is described below.

In operation 201 of FIG. 2, the application domain determines the set of packet/frame types for which QoS treatment with higher priority is needed (e.g., high bandwidth, low delay application may prefer specific handling in case of extreme congestion).

Operation 202 of FIG. 2 shows the AF to NEF packet signature and the flow details. Packet signature for packet/frame types from FIG. 2, operation 201 are sent by the AF in the application domain to the network exposure function (NEF) in the 5G-CP domain, along with flow details. Flow details may include an application identifier (applicationId), server address (app_srv_addr) on the application domain. The QoS policy may be applied to all UE flows that match data network name (DNN), single-network slice selection assistance information (S-NSSAI), and app_srv_addr. Thus, the variables may include applicationId, app_srv_addr, DNN, S-NSSAI, and/or {set of PSD, PPM}.

For the UE-UE peering flows, which are not shown in FIG. 2, packet signatures for packet types between two UEs that match an origin/destination DNN, S-NSSAI may be shared. In this case the variables include origin {DNN, S-NSSAI} or destination {DNN, D-NSSAI}, {set of PSD, PPM}. The NEF processes and stores in user data repository (UDR) as PSD types that the session management function (SMF) can subscribe to.

In operation 203 of FIG. 2, the SMF subscribes to the PSD for the DNN, S-NSSAI that it serves. PSD information and QoS treatment may be obtained from the UDR. The SMF configures each traffic assistant (TA) that it handles with the PSD and the associated PPM. A TA can be a functional entity that may be an independent network function (NF) or part of the user plane function (UPF).

Operation 204 of FIG. 2 shows flow handling at the TA. When a flow arrives at the TA, the PSD match criteria configured by the SMF is applied to the flow. The classification result with PPM may be carried with the flow in a header (e.g., GTP header extension). Subsequent scheduling uses QoS procedures in TS23.501, 5.7 for flow scheduling. In case of congestion where packets within a flow need to be selectively dropped, the TA classification priority is used without need for further examination of the packet. This may be done at other UPFs or in the radio access network (RAN).

Features to support this embodiment functionality may include the following:
a system for packet signature and drop priority classification between the application function and 5GC (AF-5GC) and 5GC enhancements to configure packet signature information in the user plane,
user plane enhancements for packet signature matching and setting drop PPM and congestion handling enhancements to drop packets based on combination of PPM and congestion threshold levels for a flow type/5G QoS identifier (5QI),
control plane enhancements to provision static PSD match data and PPM, and dynamic (packet forwarding control protocol (PFCP) session) match/action for PSD data, and
PPM carried in GTP encapsulation for use throughout 3GPP domain.

Classification of application packets and frames may take the approach of using a function to classify packets and frames within a flow in the 3GPP network. The classification mark is then used throughout the path (e.g., encapsulated in GTP extension) to avoid re-classification and still provide the ability for differentiated packet/frame based QoS handling during high congestion.

Packets and frames can be classified for drop priority using a packet signature and corresponding packet handling (e.g. setting drop priority marking). This drop priority can then be used by the first user plane function to match on packet signature and mark packet priority (action). Subsequent user plane functions can use flow based QoS handling in TS 23.501, 5.7. If there is high network congestion, the drop priority marking can be used to determine if the packet/frame should be dropped.

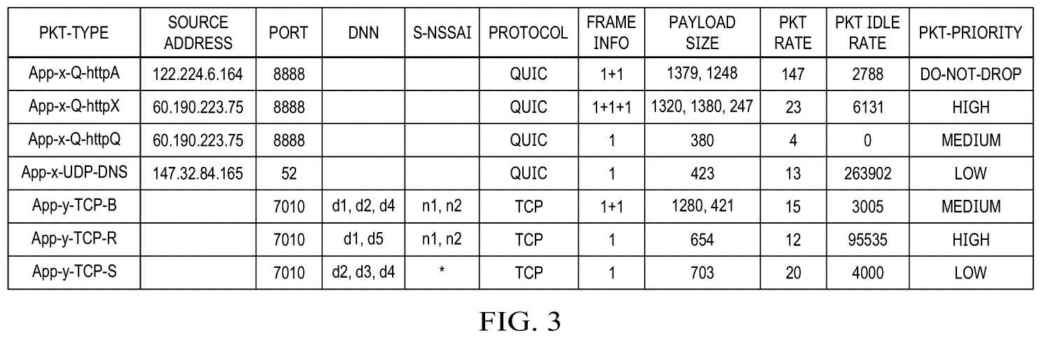

Traffic classification done using deep packet inspection (DPI) requires significant computing resources and only works when packets are not encrypted. In this disclosure, both encrypted and unencrypted scenarios are considered. Therefore, a lightweight mechanism that uses packet and frame characteristics that provide a packet signature is used. Packet signature data containing several match fields can include the 3-tuple (source, port, protocol), DNN/S-NSSAI/protocol, frame info, payload size, rate, idle time, interval, and/or other fields which describe the characteristic of the packet(s) and can be used to classify the packet. When a match on packet signature is found, the corresponding packet handling is executed, such as the PPM being assigned. If no specific per-packet handling information is provided, the system may assign the lowest priority to the packet. An embodiment example of packet signature data is shown in FIG. 3.

In one example embodiment, a packet classification engine uses the configured packet characteristics in packet signature (match fields) to mark packets with PPM/drop priority (action field). PPM is used during flow scheduling, and in case of network congestion, packets/frames are dropped at a configured rate for a level of network congestion for a PPM and QoS profile of the flow (e.g., 5QI).

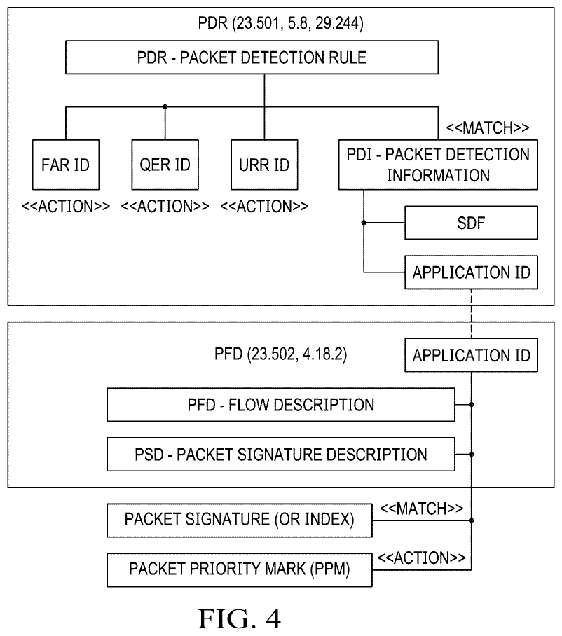

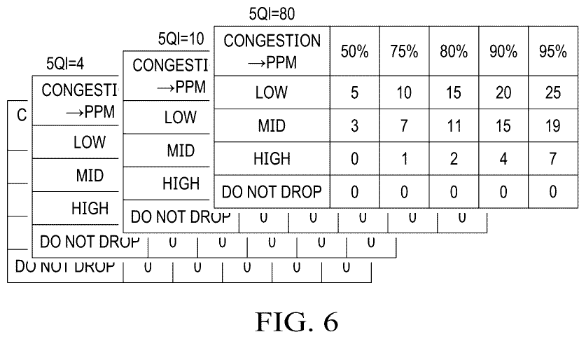

In addition to the match/action fields above, the AF may also provide a congestion drop rate, as shown in the drop rate examples in FIG. 6, if there is a service assurance contract between the application provider and the 5G operator. The operator may use the AF-5GC and operator internal tables configured on user plane nodes to satisfy the service guarantees. The data structures to provision the packet/frame signature and priority mark may extend the existing data structures as shown in FIG. 4, according to some embodiments.

Current QoS mechanisms rely on matching service data flow (SDF) and application fields (e.g., 3-tuple flow description in packet flow description (PFD)) in the packet detection information (PDI) and then applying the forwarding action rules (FAR), QOS enforcement rule (QER), and usage reporting rule (URR).

An example embodiment adds PSD data including the packet signature match fields (such as shown in the example data in FIG. 3), and corresponding packet handling policy (e.g., PPM or other priority index that is then used for handling congestion drop priority). The PSD may be organized as in option 1 or option 2 described below:
option 1: new data structure associated to the application ID (applicationId->psdId):
Data fields packet-signature data and PPM in a new data structure: psdId|{packetSignature, ppm}
option 2: extension to the PFD data (applicationId->pfdId):
Data fields packet-signature and PPM added to pfd in TS 29.551, 5.6.2.5: pfdId|{flowdescriptions}|{urls}|{domain-names}|dn-protocol|{packetSignature, ppm}
Note: bracketed data above {X} indicates an array of X.

In both option 1 and option 2, all PSD data for each “applicationId” in the PDI is matched, and the corresponding “PPM” values are applied to the packet. In option 2 (extension to PFD data), the “pfdId” may only contain “packetSignature, ppm” data, as a match is required on all fields. Option 1 may be more efficient in searching, since the application of the PSD rule to packets is independent of other flow rules (FAR, QER, etc.).

In some embodiments, PPM classification is only needed once in the network. Once derived, the PPM can be carried to other nodes in the network in an encapsulated header (e.g., GTP extension field) along with the packet itself. Alternatively, the PPM may be encoded into the DSCP field of the IP header if the DSCP used for classification of the underlay transport such as MPLS. However, this may not always be practical to do on a per packet basis for all flows.

Packet signature and priority data are provisioned between the application domain/AF and 5GC. This static data is then used by the SMF to setup the TA.

Features to support this functionality may include the following.
Configuring PSD and PPM associated to an application identifier (may be configured as separate PSD data or extension to PFD) is needed.
PSD and PPM may be configured between application domain/5GC using out-of-band methods. The PSD and PPM configured in the UDR may be retrieved and deployed in user plane using the same control plane mechanisms.

In flow based QoS handling, the UPF applies rules and match fields provisioned in the PFCP session (match fields in PDI-SDF, application ID, and rules in FAR, QER, and URR, etc.). Application match fields are stored statically using PDR provisioning in TS 23.501. However, these mechanisms may not be able to determine the relative value of one packet/frame over another within a flow. Thus, when high network congestion is experienced, the current system drops packets within a flow randomly and this may have a negative effect beyond the loss of just a packet if the information lost is essential to subsequent packets.

Another example embodiment builds on the flow based QoS handling in 3GPP TS 23.501, 5.7 and adds a differentiated QoS mechanism to be applied to packets/frames within a flow. The new classifier, PPM, may be used to differentiate packets within the same flow. This classifier is processed by matching “packet signature” to “PPM” based on the matches in PSD data for an application ID.

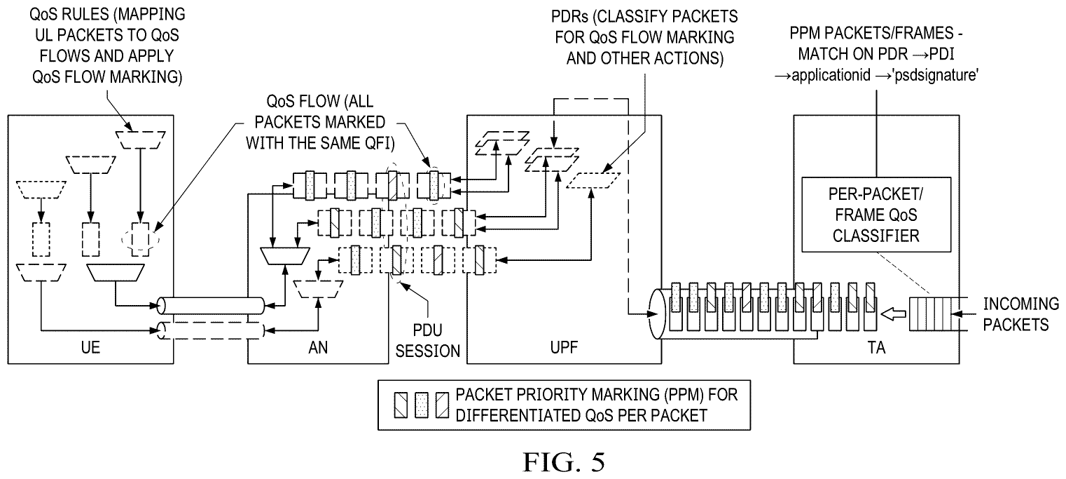

FIG. 5 shows differentiated QoS per packet and is based on TS 23.501, FIG. 5.7.1.5-1, but FIG. 5 is also enhanced to capture the aspects of some example embodiment techniques (i.e., packet priority classification and marking in the encapsulated GTP packet), according to some embodiments. FIG. 5 shows the sequence of operations for differentiated QoS handling in 5GS. As shown in the TA of FIG. 5, incoming packets to 5GS are inspected and matched based on packet signature (pdr->pdi->applicationid->packetSignature) and a corresponding packet drop priority (PPM) is added. This is done by the TA once for a packet, and the result is carried along with the flow (e.g., in GTP extension). If the application data is in a frame (i.e., subsequent packets also carry related data), the TA applies the same PPM to each of the packets that comprise the frame.

The packet is then forwarded to other user plane functions (e.g., UPF, access network (AN)) where flow based QoS procedures in TS 23.501, 5.7 are applied. When there is no network congestion, the “PPM” values are not used. However, when there is significant network congestion, the user plane functions use the “PPM” to determine drop rate. Drop rates are configured per flow type/5QI and level of network congestion. For example, average packet drop rate of 5QI=80 (low latency apps, augmented reality (AR)) at congestion level of 80% maybe different from that of 5Q1=10 (buffered streaming, e-mail, etc.). Within a flow at 5QI=80, the PPM value is used to determine priority to drop/forward. FIG. 6 shows an embodiment example of drop rates.

For each 5QI, congestion level and PPM mark on packet, the corresponding value in the drop rate table is used as a moving average of packets to be dropped during congestion. These tables are provisioned on user plane entities. Some drop rate level is used in current nodes as well, but what is different in this solution is that a packet to be dropped is not randomly decided, but rather based on the PPM value. If a packet is not tagged with a PPM mark, that is equal to having the lowest priority within that class (5QI)/congestion level. A network may alternatively use algorithmic values for drop rate where the algorithm is programmed to factor 5QI, congestion level and PPM value.

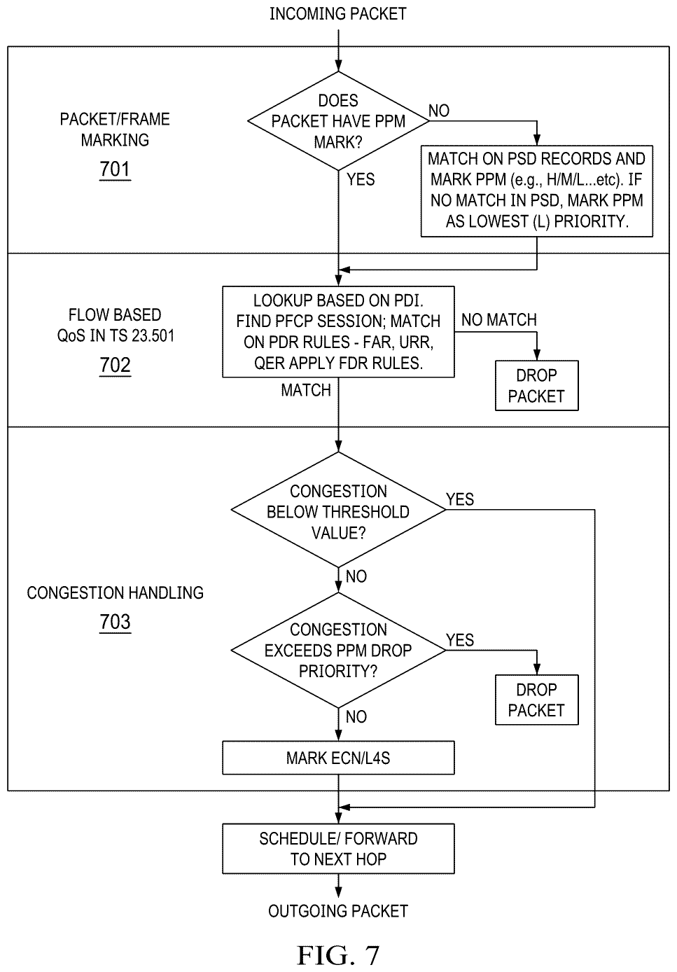

The PPM value, once classified by the TA, may be carried in a packet header through the 5GS. QoS in the UPF and the access network (AN) uses the PPM without having to evaluate or re-classify the PPM per packet. GTP extensions may be used to carry the PPM value. It should also be noted that the TA and the UPF may be co-located. The flow chart as shown in FIG. 7 shows details on the enhanced QoS processing sequence, according to some embodiments.

The enhanced QoS processing sequence has three broad stages of operation. As shown in FIG. 7, stage 701, packet/frame marking, an incoming packet in 5GS is marked with a drop priority based on packet signature data (pdr->pdi->applicationId->packet signature data). The “PPM” marking may be carried along with the flow for other user plane entities to use without the need to re-classify.

As shown in FIG. 7, stage 702, flow based QoS in TS 23.501, user plane functions apply flow based QoS procedures in TS 23.501, 5.7 (match on PDI-SDF/applicationId and apply rules in FAR, QER, URR). If there is no match (pdr->pdi->applicationId/sdf), the packet is dropped.

As shown in FIG. 7, stage 703, congestion handling, if network congestion is below a threshold value, the packet is scheduled/forwarded to the next hop. However, if network congestion is above the threshold value but does not exceed the configured drop priority level for the flow/5QI at that congestion level, the packet is marked with Explicit Congestion Notification (ECN)/L4S congestion experienced (CE) if the flow is ECN capable. The packet is then scheduled/forwarded to the next hop.

L4S/ECN marking allows the packet sender to slow down based on the frequency/intensity of congestion marks. This procedure for transports capable of this function helps reduce the queue buildup in the network but does not alleviate the need to implement network measures to manage traffic. The PPM/drop priority and L4S/ECN may work in a complementary manner.

Features to support this functionality may include the following.
Packet/frame marking procedures to classify drop priority for incoming packets in 5GS are used.
Congestion handling enhancements for dropping packets based on the configured drop priority level for the flow/5QI and PPM value of the packet are used.

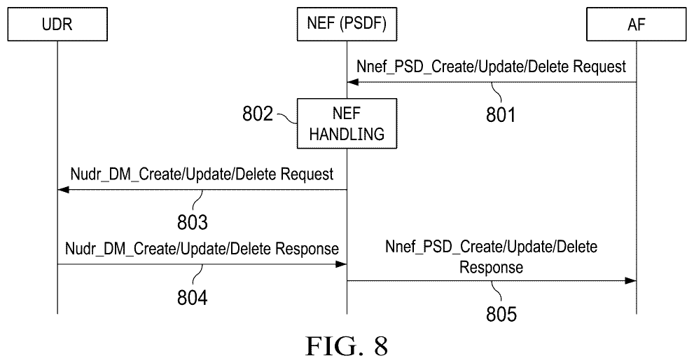

Control plane enhancements are described as follows. Configuration from AF to 5GC with NEF as PSDF is shown in FIG. 8, according to some embodiments. In FIG. 8, operation 801, The AF invokes Nnef_PSD_Create/Update/Delete request message. Packet signature match fields (including 3-tuple (source, port, protocol) or DNN/S-NSSAI/protocol, frame info, payload size, rate, idle time) and corresponding packet/frame PPM is provided.

As shown in FIG. 8, operation 802, the NEF checks whether the AF is authorized to perform this request and authorized to provision this MediaType information based on the operator policies. The NEF derives DNN and S-NSSAI from the AF Service Identifier if not received explicitly. In operation 803, the NEF invokes the Nudr_DM_Create/Update/Delete to the UDR if it is authorized. In operation 804, the UDR stores/updates/removes the corresponding information (and responds with a Nudr_DM_Create/Update/Delete Response) to the NEF. In operation 805, the NEF sends Nnef_PSD_Create/Update/Delete Response to the AF.

The sequence in FIG. 8 is based on the independent PSD data structure, described previously as option 1, and the NEF is a PSDF. If the extended PFD, option 2, is used, the sequence in TS 23.502 (PFD management) is used, but the data configured is pfdid, {packetSignature, ppm}.

For UE-UE flows, packets/frames within a flow may have differentiated Qos configured based on the DNN, S-NSSAI of origin/destination of the flow. In this case, the 5G management system installs {packetSignature, ppm} to be applied from flows that belong to the UEs at DNN, S-NSSAI. The SMF configures TAs that it manages with PSDs, QoS policy during initial policy configuration.

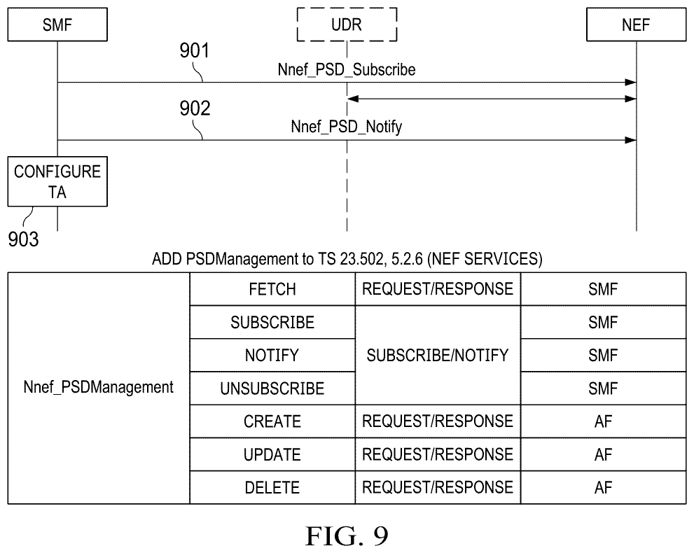

The sequence in FIG. 9 for configuring QoS policies in the TA are not per session based, according to some embodiments. In FIG. 9, operation 901, the SMF subscribes to PSD management data from the NEF. In operation 902, the NEF retrieves data from the UDR and provides the data to the SMF that has subscribed to PSD management data. In operation 903, the SMF configures the TA with the management data. The PSD is statically setup (like PFDs in TS 23.502) to apply to protocol data unit (PDU) sessions that match the configured data.

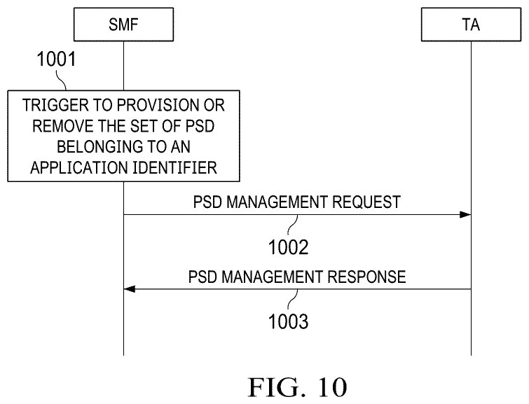

FIG. 10 shows the PSD configuration in the TA, according to some embodiments. The TA is configured with PSD information before the TA handles traffic if the previously described option 1, independent PSD data, is used. These procedures are static and not per session. As shown in FIG. 10, operation 1001, when there is a change in PSD data (new data or removal of existing data) belonging to an Application Identifier, the SMF prepares to configure the TA. In operation 1002, the SMF signals a PSD management request to the TA. In operation 1003, when the PSD data is configured in the TA, a PSD management response is sent by the TA to the SMF.

If the previously described option 2, extended PFD, is used, the procedures in TS 23.502, 4.4.3.5 may be used instead of the flows in FIG. 8 and FIG. 9 to configure PSD information as pfdid, {packetSignature, ppm} for an application (applicationId).

The PFCP session establishment/modification/delete procedures in TS 23.502, 4.3.2 (and TS 29.244, 6.3) do not currently have the specification for PSD data and PPM. The current procedures in TS 23.502, 4.3.2.2, steps 10a/10b are concerned with only the “Establishment/Modification Request to the UPF and provides Packet detection, enforcement and reporting rules to be installed on the UPF for this PDU Session.” This may be modified to also include the activate rules for “Packet signatures and PPM” along with the existing “Packet detection, enforcement and reporting rules.”

Packet signature information (PSI) provisioned includes match fields based on which the associated QoS drop priority is matched. (TS 29.244, 7.5.2). Match fields may include source, destination, or both and can be in the form of server address, port, UE addresses (source, port) that belong to a DNN/S-NSSAI. For example, for a flow from a server, the match fields may be from a server address (addr, port) to all UEs that match a DNN/S-NSSAI. In the case of a UE-UE flow, the match may be for all packets originating at a DNN/S-NSSAI, or those that match a source and destination DNN/S-NSSAI.

When TA is separate from UPF, the protocol semantics for Establish/Modify/Delete of PSI, match fields, and the PPM may be operated with signaling messages to the TA (e.g., extensions to TS 29.244).

Features to support this functionality may include the following.
Configuration of PSD data between AF-5GC and static configuration of PSD data from 5GC control plane to user plane (in either separate PSD data structure or extension to PFD) is used.
Configuration of dynamic data (PFCP session) in the PDI to match on PSD data associated with application is used.

In current user plane nodes, when there is high congestion, packets are dropped randomly within a flow that corresponds to a 5QI. When traffic is composed of high data rate and low latency applications that have varying types of packets within a flow, some form of differentiated QoS for packets and frames within the flow is used. Some example embodiments describe means by which that differentiated QoS can be realized.

Packet signature based QoS classification provides a mechanism to handle Qos priority within a flow to defer or drop using the PPM. This is also termed as “importance” in 3GPP SA2 study on extended reality and media services (XRM). While PPM provides the basic capability for handling QoS at packet granularity, it does not address how to classify a (large) group of packets (e.g., an I-frame including 400 packets) that should be treated in a consistent manner. This disclosure also provides technical solutions to this QoS aspect.

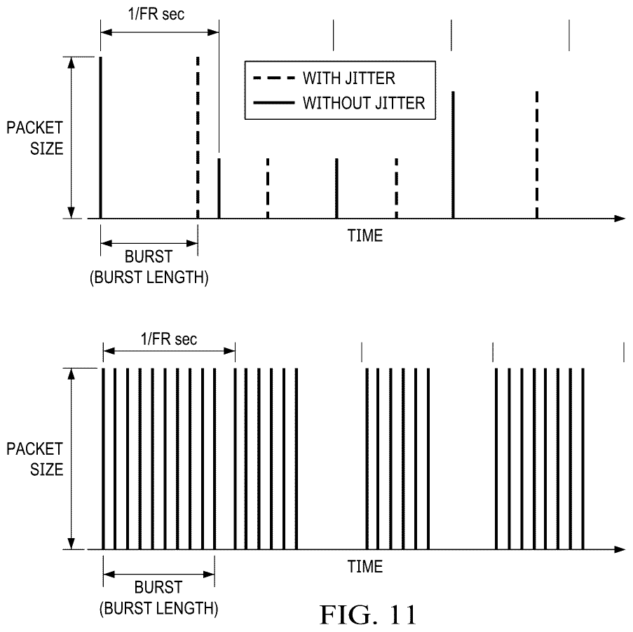

The technical issues to be addressed include identifying media packets that belong to a frame/PDU set, and classifying importance of the media packets belonging to the frame/PDU set and configuring the application information. Example embodiments with extensions to the PPM mechanism address aspects of QoS handling for either packets or a group of packets. FIG. 11, illustrating factors such as packet size, burst length, and jitter, related to multiple packets of the same media flow, is shown for reference.

For QoS classification aspects, a group of packets that form a frame or a burst, referred to as a “PDU set,” and having a sending rate of 1/FR sec may be handled together as the end user will require all of that information to process the media information. As an example, a video I-frame may include 400 packets (e.g., a frame of 600 Kb) with a frame rate (1/FR) of 16.7 ms for a 60 Frames per second transmission. In some documents, “frame,” “media unit,” and “application data unit” have similar meanings. A PDU set refers to a burst of packets within that flow that should have the same QoS handling criteria.

Some details on how the PPM and these extensions complement the current 5G QoS mechanisms specified in TS 23.501, 5.7 are provided here. The QoS handler uses the default 5QI value or a specific priority level provided for the flow to determine priority in scheduling resources available (lowest value has highest precedence). This is also associated with the packet delay budget (PDB) and packet error rate (PER) for the flow. Guaranteed bit rate (GBR), non-GBR or delay critical GBR determine handling of burst, delay, and soft delay upper bounds for the flow. However, all the above are based on a “flow,” and not based on per packet or per group of packets that form a PDU set. The extensions below support identifying packets of a PDU set, determining its relative importance/priority by marking with PPM.

Network/user plane resources for media applications tend to be overprovisioned to guarantee a near real-time experience due to the rate variability inherent in these flows. However, the network can utilize scarce network resources better and defer packet forwarding or handle congestion better if it is aware of the importance of the coded media information and mark the packets of a PDU set accordingly. QoS handling also benefits from distinguishing a PDU set from adjacent ones.

XR media may include audio, video, haptic, and/or other data that has significant rate variability. It is conveyed between media application end points over a 5G core and radio network that experiences congestion, delay, and jitter. Media applications partition data into coding layers (e.g., video coding layer (VCL)) that efficiently code the data into base layers and enhanced temporal, spatial, and quality layers. The layered media data is mapped to network adaptation layers (NAL) that are suitable to be packetized and transported across the network. Each NAL unit transported in a data packet carries an indication of the priority and dependencies to other coding layers/NAL units.

The media payload with the NAL header may be transported by real-time transport protocol (RTP) or secure real-time transport protocol (SRTP). The RTP header contains sequence number, timestamp, and M bit that are used to identify packets that belong to a PDU set. Payload information in NAL unit (NRI and Type) or experimental RTP extended header provides information on the type of payload data and is used to determine the importance of the packet. For RTP transport with unencrypted header and payload, the payload header/NAL unit information can be used. SRTP transport where the payload is encrypted must rely on the extended header if available or on the application using different IP header fields (IPv6 flow labels, DSCPs, sending ports) that correspond to the level of importance of the encoded media.

Below may be some assumptions for some example embodiments disclosed herein.
QoS handlers are presented with the same set of importance information and PDU set boundaries regardless of the format of the media transport or media codecs used.
Shallow packet inspection/meta-information from headers is preferable to minimize classification time.
Information in RTP headers, payload headers (NAL), extended RTP header and IP headers are sufficient to characterize importance and PDU set boundaries.
Fully encrypted media transport (i.e., quick user datagram protocol (UDP) internet connections (QUIC)) is not considered.
The solutions in this disclosure do not depend on SDP, HTTP or other session signaling since they do not provide per packet information.

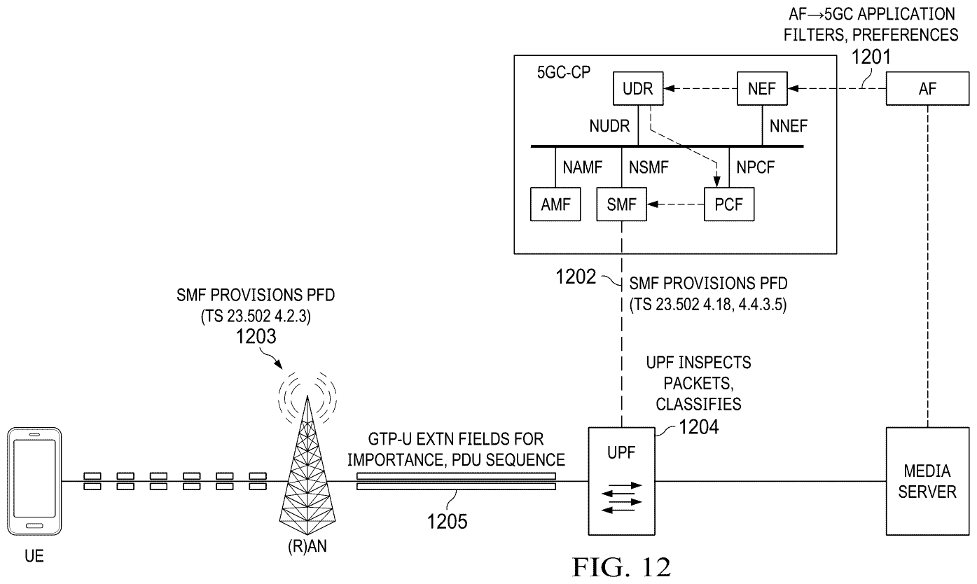

FIG. 12 shows a sequence of operations for packet handling and is described as follows, according to some embodiments. In FIG. 12 operation 1201, the AF provisions application preferences for filtering and PDU classifications in the 5GC. In FIG. 12 operation 1202, the SMF provisions PFDs in the UPF for media handling (TS 23.502 4.18, 4.4.3.5). During session establishment, the SMF provisions the PDR in the UPF (TS 23.502, 4.2.3) as shown in FIG. 12 operation 1203. In FIG. 12 operation 1204, the UPF inspects and classifies importance of packets of PDU sets using provisioned rules. In FIG. 12 operation 1205, the UPF encodes the importance and packets of the PDU sequence mark in the GTP user plane (GTP-U) extension header.

Packets belonging to a PDU set can be identified by inspecting a combination of fields in the RTP header (sequence number, timestamp, M bit) and RTP header extensions (e.g., internet engineering task force (IETF) Frame Marking RTP Extension header, and the media payload header (e.g., RTP payload NAL Unit Type field).

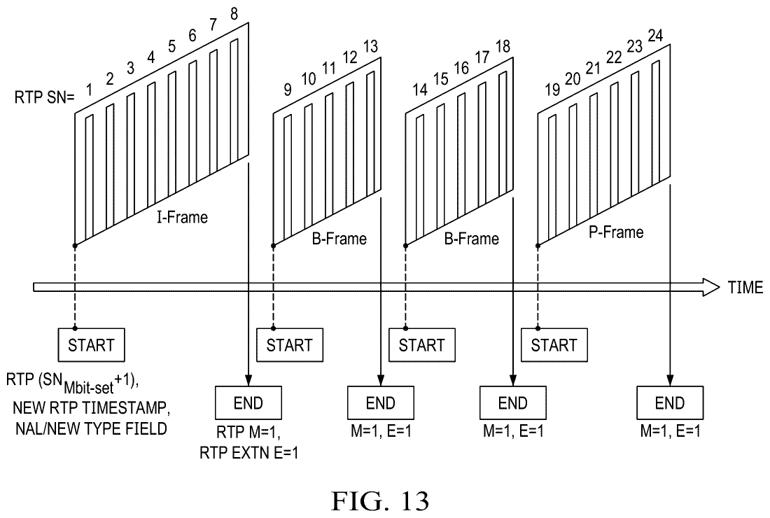

FIG. 13 illustrates the identification of the start and end of a PDU set, according to some embodiments. The first packet of a PDU set has an RTP header with new timestamp, a new Type field in NAL unit header and follows the sequence number of the packet with the RTP header M-bit set to 1 (i.e., sequence number is 1 greater than the packet with M-bit set to 1). Detection of the first packet may need a combination of fields since timestamp may not be incremented for enhanced layers (PDU set). If an RTP experimental extension header is present, the S-bit is set to 1. These fields can be used to identify the start of a PDU set.

The last packet of a PDU set has the RTP header M-bit set to 1, or precedes packet/sequence number with new timestamp. If an RTP experimental extension header is present, the E-bit is set to 1.

All the packets of a PDU set (start to end packets) are marked with a spin-bit (1-bit) that alternates values between PDU sets. More than one bit may be used for the PDU sequence mark (PSM) if out-of-order packets span multiple PDU sets. For example, a 2-bit counter would cycle incrementally through 4 distinct PDU sequence marks using modulo arithmetic (i.e., mod-4 in this case) for each subsequent PDU set. This allows the QoS handler to make decisions based on the PDU set as a whole and differentiate from previous or subsequent PDU sets. The PDU sequence mark is carried in the GTP extension.

Since packets may arrive out-of-order, a packet with an out-of-order sequence number may be part of a new PDU set. If the packet has a new timestamp and new media header fields, the packet belongs to a new PDU set and a higher PDU sequence mark (i.e., (current PSM+1) mod-n) is used to indicate that it belongs to a different PDU set.

Packets of a PDU set can be classified based on the importance of the media payload that the packets carry. Media payload header NAL or RTP extended headers contain information on media priority and dependence. Some PDU sets have a well understood importance (e.g., an independent frame has high importance, or a discardable frame has low importance) but in other cases applications may indicate a preference (e.g., an application that contains high speed motion may give higher importance to temporal enhancement PDU sets over spatial or quality data).

QoS handlers are provided with a PPM that represents importance and dependence in terms of a linear priority value (e.g., high/medium/low, 0-7). A QOS handler may use PPM along with PDU set boundaries to handle packets of a flow without the need to understand the specifics of various coded media. The PPM can thus be extensible for new types of media. It is noted that PDU Priority Mark and Packet Priority Mark are the same field.

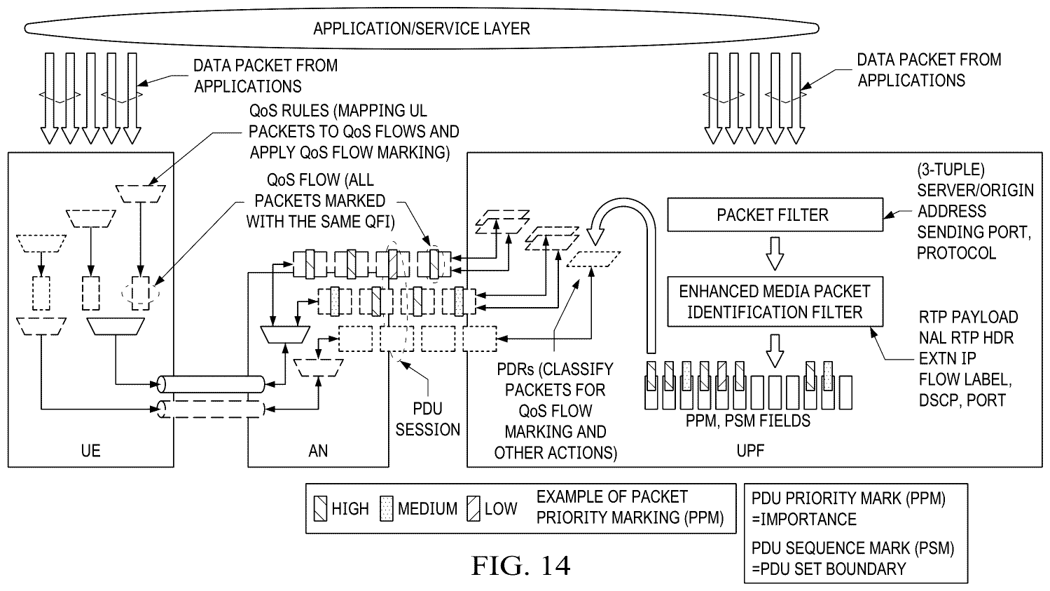

The QoS model in TS 23.501, 5.7 may be extended for media packet handling as shown in FIG. 14, according to some embodiments. Packets that arrive at a UPF with media classification functionality are filtered and classified based on origin (3-tuple) or 5-tuple flow information as defined in TS 23.501, 5.6.7. Media packet filtering information is provisioned in 5GC by the AF. If it is not a media packet, the packet bypasses the media filter and flow based QoS is handled as defined in TS 23.501, 5.7. Media packets (that are filtered) are classified using RTP header/payload header information that identifies the importance of the packet payload. The importance information in PPM and sequence of PDU sets is carried in the GTP extension header.

The mapping from meta-information available in media transport is presented to the QoS handler as a scale of increasing/decreasing priorities in PPM (e.g., high/medium/low, scale 0-7). The PPM is only applicable for selective handling (e.g., deferring, dropping) of packets within a flow. The actions that the QoS handler takes based on PPM is based on network conditions or other factors and implementation of the QoS handler and are not further defined here.

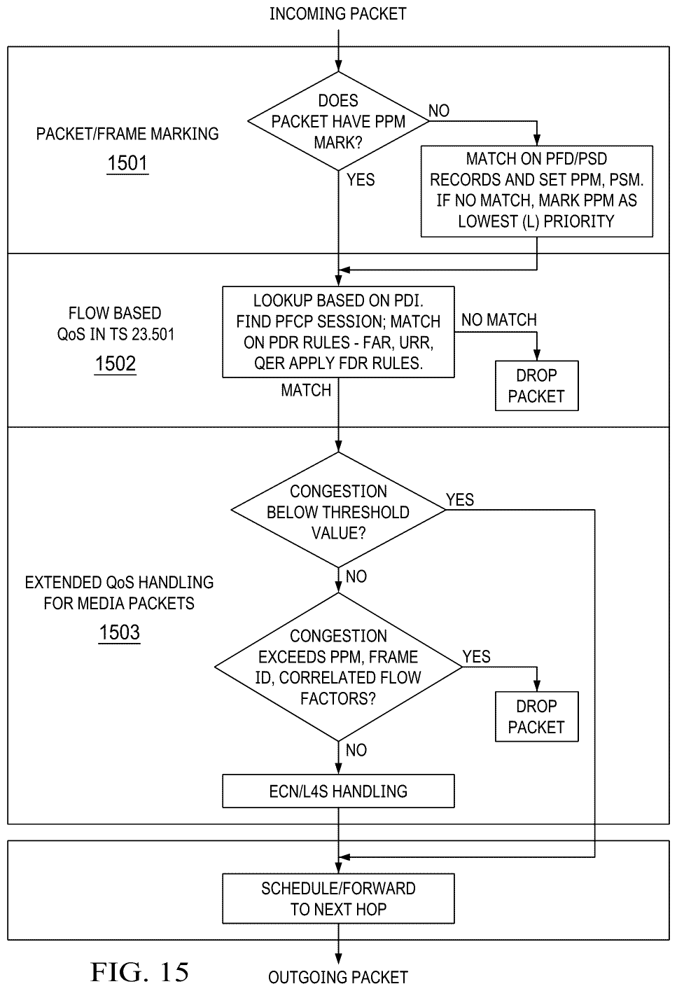

A UPF with media classification functionality follows the extended QoS handling as shown in FIG. 15 and described in the sequence of operations as follows, according to some embodiments. As shown in stage 1501, packet/PDU set marking, if an incoming packet matches media filter criteria and is not classified (i.e., does not have PPM), the enhanced media identification filter uses configured rules to select the PPM value by matching on RTP/payload header fields of incoming packet. If there is no match, packet is marked with PPM of lowest priority. In stage 1502, flow based QoS in TS 23.501, 5.7, is applied. The flow is processed using QoS defined in 23.501, 5.7. The PDB, PER, GBR, MBR remain the same and the rules are based on existing PDR for the PDU session. In stage 1503, extended QoS handling for media packets, within the QoS rules for a flow, if PPM is available the QoS handler may use the PPM to optimize handling of the packet (e.g., deferring or selectively dropping when congestion exceeds threshold level).

For classification of upstream packets, the UE is provisioned with PPM during PDU session establishment/modification based on S-NSSAI/DNN for the PDU session. The PPM rules are sent from 5GC to the UE in N1 SM Container defined in session management procedure in TS 23.502, 4.3. PPM is used in the UE for mapping to the appropriate media access control (MAC) transmission buffers.

Packets of a PDU set have a set of headers in IP, RTP transport, and payload that can be used to assign an importance and dependence to other PDU sets. After the start of a new PDU set is detected, various header information can be used. Three cases, RTP with unencrypted header and payload, SRTP with unencrypted extended experimental header and encrypted payload, and SRTP with unencrypted header and encrypted payload are described below.

For the case of RTP with unencrypted header and payload, the RTP payload/NAL unit header with information on media coding priority, dependence (e.g., H.264, SVC) are used to map to per packet QoS priority values in PPM. Independent frames/PDU sets with no dependence are marked with the highest priority while PDU sets that carry temporal, spatial, or quality enhancements are configured on a per application basis on the level of importance.

For the case of SRTP with unencrypted extended experimental header and encrypted payload, the experimental IETF draft with extended header contains coded media information that can be used to map to a PPM value. For example, an “I” (independent/IDR frame with temporal independence) may be marked important, while selected layer identifier (LID)/temporal identifier (TID) values (spatial/quality/temporal frames with dependence indicated by the value) may be of medium PPM priority and the others marked low.

For the case of SRTP with unencrypted header and encrypted payload, the RTP unencrypted header does not provide meta-information to determine the coded media that is carried in the packet, and the NAL unit header is part of the encrypted payload. Since the unencrypted headers do not convey enough information on the media carried, the application supplements by conveying different desired QoS handling priority by using different IPV6 flow labels, DSCP, sender ports. The values are configurable per application.

Provisioning may be needed to filter the media packets and apply the Qos classification based on the importance that applications need for different media encoding. For example, a video stream that encodes significant motion may wish to prioritize packets that have enhancement layers with temporal information over packets that carry quality.

For media packet filtering, the application function (AF) signals the 5GC and provides details on the criteria by which to filter traffic carrying media traffic and then to the criteria by which to determine importance of a packet. Media traffic is identified using 3-tuple (server address/end user address, port protocol) or 5-tuple flow as described in TS 23.501, 5.6.7 (Application Function Influence on Traffic Routing).

For media packet classification or enhanced media identification filtering, the media traffic is classified using the rules configured based the application priorities for the corresponding fields in the RTP/SRTP transport or payload header. Some PDU sets have a well understood importance (e.g., an independent frame has high importance, or a discardable frame has low importance) but in other cases applications may indicate a preference (e.g., an application that contains high speed motion may give higher importance to temporal enhancement PDU sets over spatial or quality data).

The AF sends information to 5GC to configure default and application specific information as described for the three cases below.

For the case of RTP with unencrypted header and payload, the parameters may be configured as follows. If the NAL I flag is set to 1, then the PPM is set to high importance. The NAL priority field values set for enhanced layers are mapped to PPM based on application preference for motion or quality. If no configuration applies, the default is to set PPM to low importance.

For the case of SRTP with unencrypted extended experimental header and encrypted payload, the parameters configured may be based on the RTP extension header. If the I flag is set to 1, then the PPM is set to high importance. If the D flag is set to 1, then the PPM is set to low importance. TID/LID/TLoPICIDX values are mapped to PPM based on application preference for motion or quality. If no configuration applies, the default is to set PPM to low importance.

For the case of SRTP with unencrypted header and encrypted payload, the parameters configured may include (one or more of) the following: IPv6 flow label values corresponding to application preference for importance of the packet, DSCP corresponding to application preference for importance of the packet (e.g., if DSCP is equal to di, then PPM is set to high importance), sending IP port and corresponding importance in PPM (e.g., if sending port is equal to p1, then PPM is set to medium importance). If no configuration applies, the default is to set PPM to low importance.

These parameters may be configured using packet flow description (PFD) procedures in TS 23.502, 4.18 and TS 23.503, 4.2.4 as basis (AF->NEF (PFDF)->UDR). The SMF subscribes to PFDManagement services from NEF to retrieve the configuration as specified in TS 23.502, 5.2.6 (NEF Services). The SMF uses N4 PFD management procedure in TS 23.502, 4.4.3.5 to provision these PFDs in the UPF.

The classification of media packets with PPM and sequence of PDU sets may be carried to QoS handlers in RAN/other UPFs using GTP-U extension headers (TS 23.501, 8.3.1, TS 29.281). New GTP extension header fields may be required for PPM/importance information and for boundaries/sequence of PDU sets.

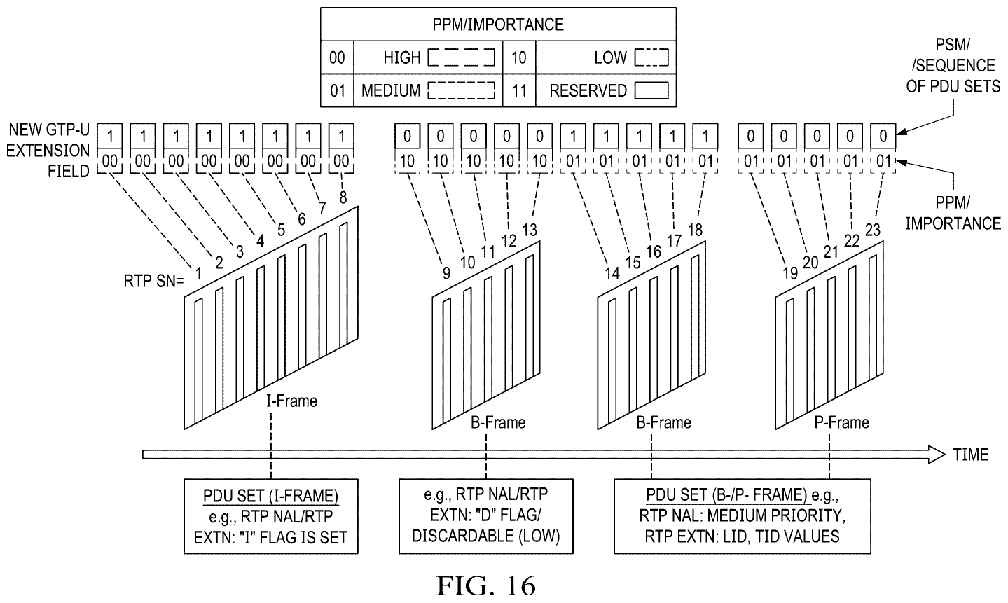

An example of GTP-U encapsulation carrying the QoS media classification result with a sequence of PDU sets (I-frame followed by B-frames and P-frame) is shown in FIG. 16, according to some embodiments. There are two sets of classification results that are carried in the GTP-U extension. The field with importance of each packet defined as PPM contains the level of importance of each PDU set. In the example here, 3 levels of importance are conveyed for a QoS handler to act on.

PDU set boundaries are identified, and each of the PDU sets is alternatively marked with a spin bit 0/1 as shown in FIG. 16 PSM/sequence of PDU sets. A larger parameter field with modulo-n counter can account for out-of-order packet handling that extends beyond the time for a PDU set.

Features for supporting this functionality may include the following:
1) a mechanism to identify a sequence of packets that belong to a single PDU set (e.g., a frame) using a combination of RTP fields (sequence number, M-bit, timestamp, S, E bits), where the start packet is identified by either the S-bit or the subsequent packet after M-bit set to 1, and a new timestamp; the end packet where the M-bit is set to 1 or precedes a packet with new timestamp; and packets within the frame/PDU set have sequentially increasing RTP sequence numbers,
2) a PDU sequence mark field that has the same value for all packets of the PDU set (frame) identified in (1), where the value of PDU sequence mark is incremented by 1 for packets of a subsequent PDU set, and where the PDU sequence mark field uses modulo arithmetic to populate the field,
3) deriving the PPM by inspecting packet header values in RTP payload NAL unit header for unencrypted payloads, RTP extension header for encrypted payloads that use experimental RTP extension header or explicitly configured values for IPV6 flow label, DSCP, sending port, or a combination of the above fields for encrypted payloads that do not have an experimental RTP extension header to identify the importance of a packet payload,
4) GTP extension fields to carry the PDU sequence mark in (2) and PPM mark in (3),
5) a mechanism to provision PPM rules in the UE during session establishment using the N1 SM container, where the PPM mapping is used to map UE application packets to appropriate radio layer MAC transmission buffer, and
   configuration of rules between application domain (AF) and 5GC that specify parameters in the IP header, transport header or payload header and matching importance level in PPM that is used in (3), where the PPM assigned is high importance for independent frames, low importance for discardable frames and per application configuration of importance for enhanced layers based on application preferences for motion or quality.

In current user plane nodes, when there is high congestion, packets are dropped randomly or deferred within a flow that corresponds to a 5QI. When traffic is composed of high data rate and low latency applications that have varying types of packets within a flow, some form of differentiated QoS for packets and frames within the flow may be utilized. The solutions in this disclosure provide means by which that differentiated QoS can be achieved.

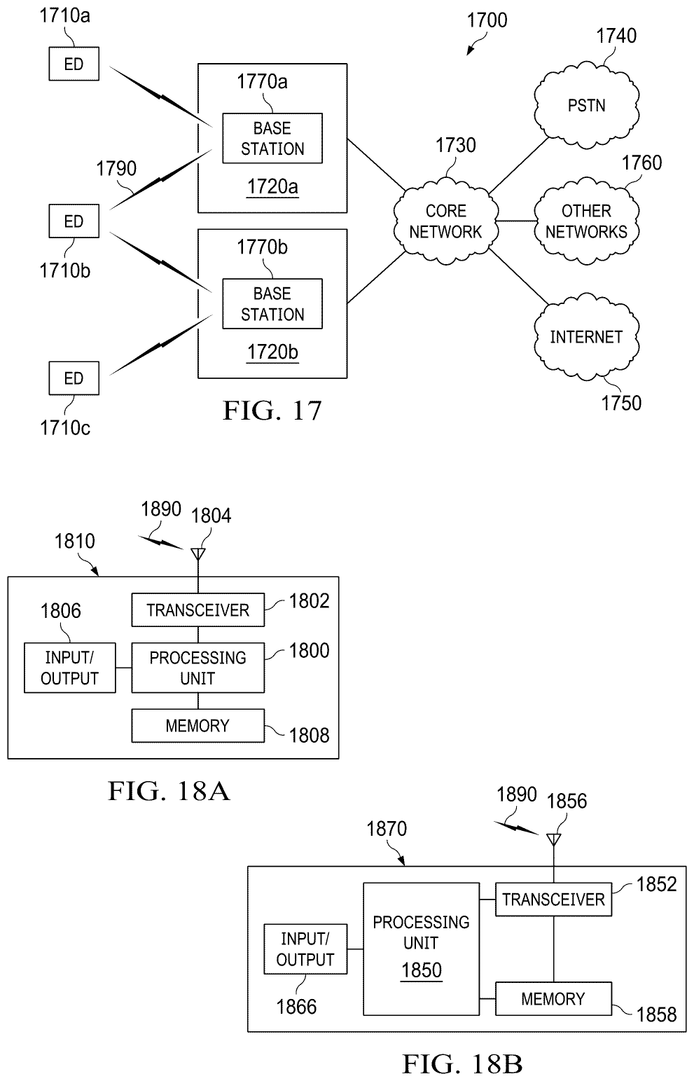

FIG. 17 illustrates an example communication system 1700. In general, the system 1700 enables multiple wireless or wired users to transmit and receive data and other content. The system 1700 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1700 includes electronic devices (ED) 1710a-1710c, radio access networks (RANs) 1720a-1720b, a core network 1730, a public switched telephone network (PSTN) 1740, the Internet 1750, and other networks 1760. While certain numbers of these components or elements are shown in FIG. 17, any number of these components or elements may be included in the system 1700.

The EDs 1710a-1710c are configured to operate or communicate in the system 1700. For example, the EDs 1710a-1710c are configured to transmit or receive via wireless or wired communication channels. Each ED 1710a-1710c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1720a-1720b here include base stations 1770a-1770b, respectively. Each base station 1770a-1770b is configured to wirelessly interface with one or more of the EDs 1710a-1710c to enable access to the core network 1730, the PSTN 1740, the Internet 1750, or the other networks 1760. For example, the base stations 1770a-1770b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1710a-1710c are configured to interface and communicate with the Internet 1750 and may access the core network 1730, the PSTN 1740, or the other networks 1760.

In the embodiment shown in FIG. 17, the base station 1770a forms part of the RAN 1720a, which may include other base stations, elements, or devices. Also, the base station 1770b forms part of the RAN 1720b, which may include other base stations, elements, or devices. Each base station 1770a-1770b operates to transmit or receive wireless signals within a particular geographic region or area, sometimes referred to as a “cell.” In some embodiments, multiple-input multiple-output (MIMO) technology may be employed having multiple transceivers for each cell.

The base stations 1770a-1770b communicate with one or more of the EDs 1710a-1710c over one or more air interfaces 1790 using wireless communication links. The air interfaces 1790 may utilize any suitable radio access technology.

It is contemplated that the system 1700 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1720a-1720b are in communication with the core network 1730 to provide the EDs 1710a-1710c with voice, data, application, Voice over Internet Protocol (VOIP), or other services. Understandably, the RANs 1720a-1720b or the core network 1730 may be in direct or indirect communication with one or more other RANs (not shown). The core network 1730 may also serve as a gateway access for other networks (such as the PSTN 1740, the Internet 1750, and the other networks 1760). In addition, some or all of the EDs 1710a-1710c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1750.

Although FIG. 17 illustrates one example of a communication system, various changes may be made to FIG. 17. For example, the communication system 1700 could include any number of EDs, base stations, networks, or other components in any suitable configuration.

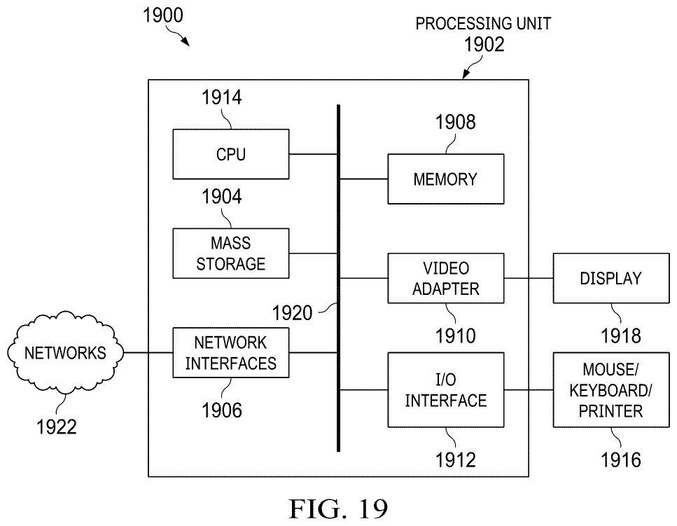

FIG. 18A and FIG. 18B illustrate example devices that may implement the methods and teachings according to this disclosure. In particular, FIG. 18A illustrates an example ED 1810, and FIG. 18B illustrates an example base station 1870. These components could be used in the system 1700 or in any other suitable system.

As shown in FIG. 18A, the ED 1810 includes at least one processing unit 1800. The processing unit 1800 implements various processing operations of the ED 1810. For example, the processing unit 1800 could perform signal coding, data processing, power control, input/output processing, or any other functionality enabling the ED 1810 to operate in the system 1700. The processing unit 1800 also supports the methods and teachings described in more detail above. Each processing unit 1800 includes any suitable processing or computing device configured to perform one or more operations. Each processing unit 1800 could, for example, include a microprocessor, microcontroller, digital signal processor, field programmable gate array, or application specific integrated circuit.

The ED 1810 also includes at least one transceiver 1802. The transceiver 1802 is configured to modulate data or other content for transmission by at least one antenna or NIC (Network Interface Controller) 1804. The transceiver 1802 is also configured to demodulate data or other content received by the at least one antenna 1804. Each transceiver 1802 includes any suitable structure for generating signals for wireless or wired transmission or processing signals received wirelessly or by wire. Each antenna 1804 includes any suitable structure for transmitting or receiving wireless or wired signals. One or multiple transceivers 1802 could be used in the ED 1810, and one or multiple antennas 1804 could be used in the ED 1810. Although shown as a single functional unit, a transceiver 1802 could also be implemented using at least one transmitter and at least one separate receiver.

The ED 1810 further includes one or more input/output devices 1806 or interfaces (such as a wired interface to the Internet 1750). The input/output devices 1806 facilitate interaction with a user or other devices (network communications) in the network. Each input/output device 1806 includes any suitable structure for providing information to or receiving information from a user, such as a speaker, microphone, keypad, keyboard, display, or touch screen, including network interface communications.

In addition, the ED 1810 includes at least one memory 1808. The memory 1808 stores instructions and data used, generated, or collected by the ED 1810. For example, the memory 1808 could store software or firmware instructions executed by the processing unit(s) 1800 and data used to reduce or eliminate interference in incoming signals. Each memory 1808 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 18B, the base station 1870 includes at least one processing unit 1850, at least one transceiver 1852, which includes functionality for a transmitter and a receiver, one or more antennas 1856, at least one memory 1858, and one or more input/output devices or interfaces 1866. A scheduler, which would be understood by one skilled in the art, is coupled to the processing unit 1850. The scheduler could be included within or operated separately from the base station 1870. The processing unit 1850 implements various processing operations of the base station 1870, such as signal coding, data processing, power control, input/output processing, or any other functionality. The processing unit 1850 can also support the methods and teachings described in more detail above. Each processing unit 1850 includes any suitable processing or computing device configured to perform one or more operations. Each processing unit 1850 could, for example, include a microprocessor, microcontroller, digital signal processor, field programmable gate array, or application specific integrated circuit.

Each transceiver 1852 includes any suitable structure for generating signals for wireless or wired transmission to one or more EDs or other devices. Each transceiver 1852 further includes any suitable structure for processing signals received wirelessly or by wire from one or more EDs or other devices. Although shown combined as a transceiver 1852, a transmitter and a receiver could be separate components. Each antenna 1856 includes any suitable structure for transmitting or receiving wireless or wired signals. While a common antenna 1856 is shown here as being coupled to the transceiver 1852, one or more antennas 1856 could be coupled to the transceiver(s) 1852, allowing separate antennas 1856 to be coupled to the transmitter and the receiver if equipped as separate components. Each memory 1858 includes any suitable volatile or non-volatile storage and retrieval device(s). Each input/output device 1866 facilitates interaction with a user or other devices (network communications) in the network. Each input/output device 1866 includes any suitable structure for providing information to or receiving/providing information from a user, including network interface communications.

FIG. 19 is a block diagram of a computing system 1900 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1900 includes a processing unit 1902. The processing unit includes a central processing unit (CPU) 1914, memory 1908, and may further include a mass storage device 1904, a video adapter 1910, and an I/O interface 1912 connected to a bus 1920.

The bus 1920 may be one or more of any type of several bus architectures including a memory bus or memory controller, a peripheral bus, or a video bus. The CPU 1914 may comprise any type of electronic data processor. The memory 1908 may comprise any type of non-transitory system memory such as static random access memory (SRAM), dynamic random access memory (DRAM), synchronous DRAM (SDRAM), read-only memory (ROM), or a combination thereof. In an embodiment, the memory 1908 may include ROM for use at boot-up, and DRAM for program and data storage for use while executing programs.

The mass storage 1904 may comprise any type of non-transitory storage device configured to store data, programs, and other information and to make the data, programs, and other information accessible via the bus 1920. The mass storage 1904 may comprise, for example, one or more of a solid state drive, hard disk drive, a magnetic disk drive, or an optical disk drive.

The video adapter 1910 and the I/O interface 1912 provide interfaces to couple external input and output devices to the processing unit 1902. As illustrated, examples of input and output devices include a display 1918 coupled to the video adapter 1910 and a mouse, keyboard, or printer 1916 coupled to the I/O interface 1912. Other devices may be coupled to the processing unit 1902, and additional or fewer interface cards may be utilized. For example, a serial interface such as Universal Serial Bus (USB) (not shown) may be used to provide an interface for an external device.

The processing unit 1902 also includes one or more network interfaces 1906, which may comprise wired links, such as an Ethernet cable, or wireless links to access nodes or different networks. The network interfaces 1906 allow the processing unit 1902 to communicate with remote units via the networks. For example, the network interfaces 1906 may provide wireless communication via one or more transmitters/transmit antennas and one or more receivers/receive antennas. In an embodiment, the processing unit 1902 is coupled to a local-area network 1922 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method comprising:
receiving, by a network node, a packet in an internet protocol (IP) flow;
determining, by the network node, that the packet in the IP flow is a media packet using an enhanced media identification filter;
obtaining, by the network node, a packet priority mark (PPM) for the media packet, the PPM indicating an importance of the media packet;
obtaining, by the network node, a protocol data unit (PDU) sequence mark (PSM) for the media packet, the PSM indicating a sequence number for a PDU set to which the media packet belongs; and
processing, by the network node, the media packet in accordance with the PPM, the PSM, and a congestion level.

2. The method of claim 1, wherein the PDU set is a subset of a quality of service (QOS) flow, and wherein the QoS flow includes a second PDU set, each packet of the second PDU set includes a second PSM indicating a second sequence number different from the sequence number, the second PDU set corresponding to a second PPM different from the PPM.

3. The method of claim 2, wherein the QoS flow corresponds to a video stream, wherein the PDU set corresponds to a video frame of the video stream, and wherein the second PDU set corresponds to a second video frame of the video stream different from the video frame.

4. The method of claim 1, the processing comprising:
determining whether to forward or drop the media packet in accordance with the PPM, the PSM, and the congestion level.

5. The method of claim 1, the obtaining the PPM comprising:
obtaining, by the network node, the PPM using the enhanced media identification filter.

6. The method of claim 1, wherein the obtaining the PPM comprises:
mapping application meta-data in the media packet to the PPM in accordance with a mapping rule in the enhanced media identification filter, the mapping rule being statically setup in the network node.

7. The method of claim 6, wherein the mapping rule is signaled to the network node via an application function (AF) and a session management function (SMF).

8. The method of claim 1, wherein the media packet is a real time transport protocol (RTP) packet, and wherein the obtaining the PPM comprises:
mapping information in an RTP payload of the RTP packet to the PPM.

9. The method of claim 1, wherein the obtaining the PPM comprises:
setting the PPM in accordance with at least one of a network adaptation layer (NAL) independent layer or a NAL base layer.

10. The method of claim 1, wherein the obtaining the PPM comprises:
determining that a configured NAL independent (I) flag is set to 1; and
setting the PPM to indicate a high importance in response to the configured network adaptation layer (NAL) I flag being set to 1.

11. The method of claim 1, wherein the obtaining the PPM comprises:
mapping network adaptation layer (NAL) priority field values for enhanced layers to the PPM in accordance with an application preference for motion or quality.

12. The method of claim 1, wherein the obtaining the PPM comprises:
determining that no network adaptation layer (NAL) application specific information is configured; and
setting the PPM to indicate a low importance in in response to no NAL application specific information being configured.

13. The method of claim 1, wherein the media packet is a secure real time transport protocol (SRTP) packet including an unencrypted extended header, and wherein the obtaining the PPM comprises:
mapping coded media information in the unencrypted extended header to the PPM.

14. The method of claim 13, wherein the obtaining the PPM comprises:
setting the PPM to indicate a high importance in response to an I flag in the unencrypted extended header being set to 1.

15. The method of claim 13, wherein the obtaining the PPM comprises:
setting the PPM in accordance with application meta-data in the unencrypted extended header.

16. The method of claim 13, wherein the obtaining the PPM comprises:
determining that a D flag in the unencrypted extended header is set to 1; and
setting the PPM to indicate a low importance in response to the D flag being set to 1.

17. The method of claim 13, wherein the obtaining the PPM comprises:
mapping at least one of a temporal identifier (TID), a layer identifier (LID), or a temporal layer zero picture index (TLoPICIDX) value in the unencrypted extended header to the PPM based on an application preference for motion or quality.

18. The method of claim 17, wherein the obtaining the PPM comprises:
setting the PPM to indicate a low importance in response to the unencrypted extended header including no configuration related to the PPM.

19. The method of claim 1, wherein the media packet is one of a secure real time transport protocol (SRTP) packet or a hypertext transfer protocol (HTTP) packet including an encrypted payload, the encrypted payload including a media payload and headers, and wherein the obtaining the PPM comprises:
mapping information in the media packet to the PPM using a configured rule in the enhanced media identification filter, the configured rule obtained from a control plane node.

20. The method of claim 19, wherein an application function (AF) node configures the configured rule to the control plane node, and wherein the configured rule specifies parameters in at least one of one or more IP headers, one or more transport headers, or one or more payload headers for mapping to the PPM.

21. The method of claim 19, wherein the obtaining the PPM comprises:
mapping at least one of one or more IPv6 flow labels, a differentiated service code point (DSCP) field, or a sending port field to the PPM using the configured rule.

22. The method of claim 19, wherein the obtaining the PPM comprises:
setting the PPM to indicate a low importance in response to at least one IP header field including no configuration related to the PPM using the configured rule.

23. The method of claim 19, wherein the obtaining the PPM comprises:
setting the PPM to indicate a high importance based on the media packet being in an independent frame as specified in the configured rule, or
setting the PPM to indicate a low importance based on the media packet being in a discardable frame as specified in the configured rule, or
setting the PPM based on an application preference for motion or quality as specified in the configured rule.

24. The method of claim 1, wherein the obtaining the PPM comprises:
determining, by the network node, that there is a match between a data network name (DNN) or a single-network slice selection assistance information (S-NSSAI) and a QoS flow of the PDU set; and
setting, by the network node, the PPM in accordance with at least one of a packet type, a service address, a port, a protocol, a frame information field, a payload size, a packet rate, or a packet idle time.

25. A network node comprising:
one or more processors; and
a non-transitory memory storage storing instructions that, when executed by the one or more processors, cause the network node to perform operations including:
receiving a packet in an internet protocol (IP) flow;
determining that the packet in the IP flow is a media packet using an enhanced media identification filter;
obtaining a packet priority mark (PPM) for the media packet, the PPM indicating an importance of the media packet;
obtaining a protocol data unit (PDU) sequence mark (PSM) for the media packet, the PSM indicating a sequence number for a PDU set to which the media packet belongs; and
processing the media packet in accordance with the PPM, the PSM, and a congestion level.
